(19) United States
(12) Patent Application Publication
(10) Pub. No.: US 2015/0172469 A1
(43) Pub. Date: Jun. 18, 2015

(54) Method and Apparatus for Pre-Fetched Content Charging

(71) Applicant: Telefonaktiebolaget L M Ericsson (publ), Stockholm (SE)

(72) Inventors: Icaro L. J. Da Silva, Sollentuna (SE); Åsa Bertze, Spanga (SE); Jing Fu, Solna (SE); Gunnar Mildh, Sollentuna (SE); Yu Wang, Solna (SE)

(21) Appl. No.: 14/132,478

(22) Filed: Dec. 18, 2013

(51) Int. Cl. H04M 15/00

(52) U.S. Cl. CPC H04M 15/31

(57) ABSTRACT

According to one aspect of the teachings herein, preliminary or pending charging information is generated for content that is pre-fetched to a user device via a communication network. The pending charging information is finalized, e.g., for use in offline charging, responsive to determining that the pre-fetched content was consumed at the user device, or voided responsive to determining that the pre-fetched content was not consumed. Finalized charging information may reflect, for example, the amount of pre-fetched content actually consumed at the user device and other parameters, such as when and/or how the pre-fetched content was delivered, the nature of the pre-fetched content, etc. Further, the determination as to whether and/or how much of the pre-fetched content was consumed at the user device may be made based on received control-plane signaling and/or elapsed time, e.g., where the content is perishable.

### TECHNICAL FIELD

The present invention generally relates to communication networks, and particularly relates to charging for content that is pre-fetched to user equipment in such networks.

### BACKGROUND

“Optimized Scheduled Delivery” or OSD is a phrase used by Telefonaktiebolaget LM Ericsson to denote a set of technical solutions that improve communication network utilization and the Quality-of-Experience, QoE, for subscribers of communication networks. One aspect of OSD involves “pre-fetching,” in which content is transmitted to an item of user equipment for later consumption. For example, a movie or other mobile broadband content is pre-fetched to a given subscriber's wireless device for later viewing. Pre-fetching may be speculative, such as where content of general or known specific interest, such as a currently popular video, is sent to one or more wireless devices, on the likelihood that the users of those devices will at some later time want to view or otherwise “consume” that content.

Among the numerous advantages associated with content pre-fetching, whether as part of OSD or as part of some other scheme or arrangement, pre-fetching can be done at times of low network activity, meaning that network bandwidth that might otherwise go underutilized can be put to use for content pre-fetching. Further, the actual consumption of pre-fetched content at a user's device means that the network does not have to stream that content in real time and that means that the user generally will not experience the content playback interruptions that can rise during real-time streaming.

Content pre-fetching is not without challenges, however. For example, assume that a communication network is configured for content pre-fetching and that one or more subscriber devices are appropriately configured for such operation. That is, the network implements a pre-fetching function and one or more subscriber devices include some type of pre-fetching client, so that selected content, such as various items of mobile broadband content, can be pre-fetched from a content provider or from dedicated content caches in the network into local storage at the subscriber devices, for possible subsequent playback. The network knows precisely what content has been pre-fetched to which devices, and knows the parameters associated with pre-fetching, e.g., the pre-fetching times, durations, radio conditions, the involved Radio Access Technologies, RATs, the cell(s) and/or access points used for conveying the pre-fetched content to the devices, etc. However, the conventional network may not know anything about whether or when pre-fetched content is subsequently consumed at a given subscriber device.

Moreover, the current approaches to billing and policy enforcement do not encompass the complexities arising from content pre-fetching, and particularly not when premium or pay content is speculatively pre-fetched to subscriber devices. For example existing approaches to policy enforcement and charging, the interested reader is referred to TS 23.203 V 11.11.0, Policy and Charging Control Architecture, which is a technical specification promulgated by the Third Generation Partnership project.

### SUMMARY

According to one aspect of the teachings herein, preliminary or pending charging information is obtained for content that is pre-fetched to a user device via a communication network. The pending charging information is finalized, e.g., for use in offline charging, responsive to determining that the pre-fetched content was consumed at the user device, or voided responsive to determining that the pre-fetched content was not consumed. Finalized charging information may reflect, for example, the amount of pre-fetched content actually consumed at the user device and may reflect other parameters, such as when and/or how the pre-fetched content was delivered, the nature of the pre-fetched content, etc. Further, the determination as to whether and/or how much of the pre-fetched content was consumed at the user device may be made based on received control-plane signaling and/or elapsed time, e.g., where the content is perishable.

In an example embodiment, a network node implements a method of charging for content that is pre-fetched to a user device via a communication network. The network node is an Application Function or AF, an Offline Charging System or OFCS, or a Policy and Charging Enforcement Function or PCEF, for example. More generally, the network “node” may comprise any one or more of the aforementioned entities, working individually or cooperatively.

The method includes generating pending charging information responsive to content being pre-fetched to a user device, which content is referred to as pre-fetched content. The method further includes reconciling the pending charging information, based on determining whether the pre-fetched content is subsequently consumed at the user device. Reconciliation processing includes updating the pending charging information with finalized charging information responsive to determining that the pre-fetched content is subsequently at least partly consumed at the user device, and voiding the pending charging information responsive to determining that the pre-fetched content is not subsequently consumed at the user device. Here, “voiding” may comprise deleting the pending charging information, or otherwise marking it accordingly.

An example network node in another embodiment is configured for operation in a communication network that pre-fetches content to a user device. The network node includes a communication interface configured to receive signaling indicating that content has been pre-fetched to a user device, and further includes a processing circuit that is operatively associated with the communication interface. The processing circuit is configured to obtain pending charging information responsive to the content being pre-fetched to the user device, and to reconcile the pending charging information, based on determining whether the pre-fetched content is subsequently consumed at the user device. In this regard, the processing circuit is configured to update the pending charging information with finalized charging information responsive to determining that the pre-fetched content is subsequently at least partly consumed at the user device, and to void the pending charging information responsive to determining that the pre-fetched content is not subsequently at least partly consumed at the user device.

In another embodiment, a user device implements a complementary device-side method. The method includes receiving content from a communication network that is pre-fetched to the user device, and storing the pre-fetched content at the user device for subsequent consumption. The method further includes generating consumption information responsive to subsequent consumption of the pre-fetched content at the user device, and sending control-plane signaling to a network node in the communication network indicating the consumption information. Consumption information as generated by or for the user device also may indicate non-consumption—i.e., indicate that given pre-fetched content has not been consumed.

In a corresponding embodiment, a user device includes a communication interface configured to receive content from a communication network, where that content is pre-fetched to the user device. The user device further includes a processing circuit that is operatively associated with the communication interface and configured to store the pre-fetched content at the user device for subsequent consumption. The processing circuit is further configured to generate consumption information responsive to subsequent consumption of the pre-fetched content at the user device, and send signaling directly or indirectly to a network node in the communication network indicating the consumption information, e.g., to send control-plane signaling.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of one embodiment of a communication network and an associated user device, as configured according to the teachings herein.

FIG. 2 is a logic flow diagram of one embodiment of a method at a network node, for charging for content that is pre-fetched to a user device.

FIG. 3 is a logic flow diagram of one embodiment of a method at user device, for facilitating charging for content that is pre-fetched to a user device.

FIG. 4 is a block diagram of another embodiment of a communication network and an associated user device, as configured according to the teachings herein.

### DETAILED DESCRIPTION

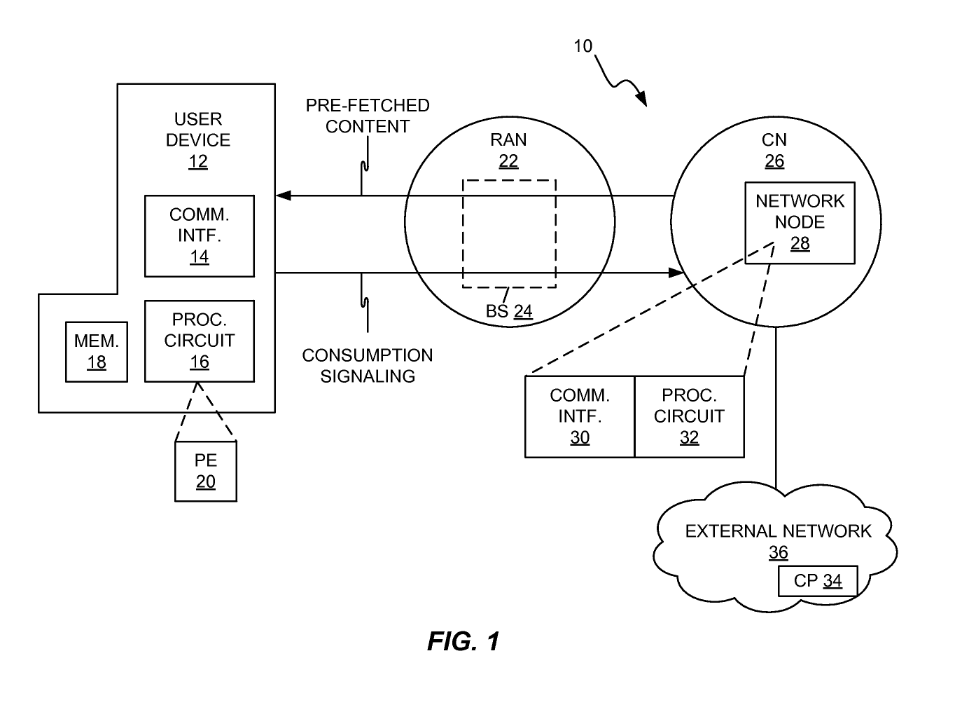

FIG. 1 illustrates one embodiment of a communication network 10 that is configured to provide communication services to a user device 12, including the pre-fetching of content to the user device 12. The term “content” as used here denotes electronic content, such as mobile broadband or other multimedia content, and should be broadly understood as encompassing a wide range of digital media, including media that is encrypted or otherwise protected by Digital Rights Management, DRM, or other security mechanisms.

By way of further non-limiting example, the term “user device” is used here in a generic sense. The term connotes essentially any apparatus configured for receiving and consuming content via the communication network 10. Examples include a “user equipment” as that term is used by the Third Generation Partnership Project or 3GPP. Other examples include smartphones, tablets, computers, PDAs, etc., which are configured for communication within the network 10 and which include user interfaces or otherwise provide for digital content consumption.

Further, the network 10 comprises, for example, a Long Term Evolution, LTE, network, an LTE-Advanced network, or a Wideband CDMA network with High-Speed Packet Access, HSPA, services. Of course, these examples are non-limiting.

With the above in mind, the user device 12 in the illustrated example includes a communication interface 14, a processing circuit 16, and memory 18. The processing circuit 16 may comprise one or more microprocessors, DSPs, or other digital processing circuitry, and may be segregated according to function, e.g., a baseband processor for cellular and/or other communications processing and control of the communication interface 14, application processing for user and/or system applications running on the user device 12, and secure or trusted computing circuitry, for handling certain types of content, such as DRM-protected content. Regardless of the particular implementation details, the processing circuit 16 implements a pre-fetching entity or PE 20, which is configured for cooperative pre-fetching in conjunction with the content pre-fetching features of the network 10.

The network 10 in the illustrated embodiment includes a Radio Access Network, RAN, 22, which includes one or more base stations 24, and a core network, CN, 26, which includes a network node 28 configured according to the teachings herein. The network node 28 includes a communication interface 30 and a processing circuit 32, the details of which are set forth by way of example in the below discussion. However, with respect to the network 10 at large, it will be appreciated by those of ordinary skill in the art that the network 10 may have additional complexity. For example, for pre-fetching support, it may have one or more content caches and/or content servers implemented in the RAN 22 and/or the CN 26, for caching content obtained from one or more content providers, CPs, 34 that are accessible through the Internet or other external network 36 that is communicatively coupled to the CN 26.

“Pre-fetched content” as that term is used herein may be pre-fetched to a given user device 12 from local caching within the network 10, or may be pre-fetched directly from a CP 34. In general, the network 10 is configured for pre-fetching content to user devices 12 and the network node 28 is configured for operation in the network 10, in the context of content pre-fetching. The communication interface 30 is configured to receive signaling indicating that the given content has been pre-fetched to a given user device 12, and the processing circuit 32, which is operatively associated with the communication interface 30, is configured to obtain pending charging information responsive to such content being pre-fetched to the user device 12. The content in this regard is referred to as pre-fetched content, to indicate that it is content that was sent to the user device 12, for later consumption from device storage.

The processing circuit 32 is further configured to reconcile the pending charging information, based on determining whether the pre-fetched content is subsequently consumed at the user device 12. Reconciliation is based on the processing circuit 32 being configured to update the pending charging information with finalized charging information responsive to determining that the pre-fetched content is subsequently at least partly consumed at the user device 12, or to void the pending charging information responsive to determining that the pre-fetched content is not subsequently at least partly consumed at the user device 12.

Here, “voiding” the pending charging information comprises deleting the pending charging information or otherwise marking the pending charging information as void or canceled, e.g., to avoid charging the user account associated with the user device 12 for pre-fetched content that is not at least partly consumed at the user device 12. It will be understood that the processing circuit 32 performs reconciliation for individual items of content that are pre-fetched to the same user device 12 and performs similar reconciliation for any number of user devices 12 to which given content is pre-fetched.

Notably, in some embodiments the processing circuit 32 is configured to update the pending charging information with finalized charging information that indicates whether the pre-fetched content was fully or partly consumed at the user device 12. Thus, for the case where the processing circuit 32 determines that given pre-fetched content was at least partly consumed at the user device 12, the finalized charging information includes a flag, field or other indication as to whether the pre-fetched content was wholly consumed or only partly consumed.

In a particular example of this approach, the processing circuit 32 is configured to update the pending charging information with finalized charging information, based on generating the finalized charging information to account for the amount of the pre-fetched content that was actually consumed at the user device 12. Usage of partial-consumption information may vary in dependence on any number of variables, such as the type of pre-fetched content, the subscription particulars of the user associated with the user device 12, the relationship between the operator of the network 10 and the CP 34 associated with the pre-fetched content, etc. Broadly, in at least some embodiments, the finalized charging information is generated or otherwise finalized to account for how much of the pre-fetched content was actually consumed at the user device 12.

In one example of accounting for the amount of pre-fetched content that is actually consumed at a given user device 12, the pre-fetched content is logically quantized into content chunks and the processing circuit 32 is configured to generate the finalized charging information to account for the amount of pre-fetched content that was actually consumed at the user device 12 on a content-chunk basis. The “amount” of pre-fetched content consumed as referred to here is not meant to be some aggregated or historical value, but rather a number, flag or other value that indicates how much a music video, movie, or other individual item of pre-fetched content was consumed at the user device 12.

Content chunking may be based on time, such as where the content is a recorded musical performance, etc., and where charging is based on how much of the performance was played back at the user device 12. Chunking may be approached differently for other types of media, e.g., where the content is the latest edition of a serial electronic news magazine, the content may be chunked on a per article basis or even a per “page” basis.

In the same or further embodiments, the finalized charging information includes one or more metadata items for the pre-fetched content, including one or more of: a time at which the pre-fetched content was delivered to the user device 12, a location of the user device 12 when the pre-fetched content was delivered to the user device 12, and a type or identity of the RAN 22, used to deliver the pre-fetched content to the user device 12. These parameters relate to the cost or burden of providing the pre-fetched content to the user device 12 and can therefore be factored into determining actual charges assessed against the user associated with the user device 12, or even for charging fees back to the originator of the content. Additionally, or alternatively, the finalized charging information includes metadata related to the consumption of the content, e.g., the time of consumption, the type of RAN that the content was consumed in, whether the content was consumed in one session or incrementally, what specific part or portions of the content was consumed if less than all of the content was consumed, etc.

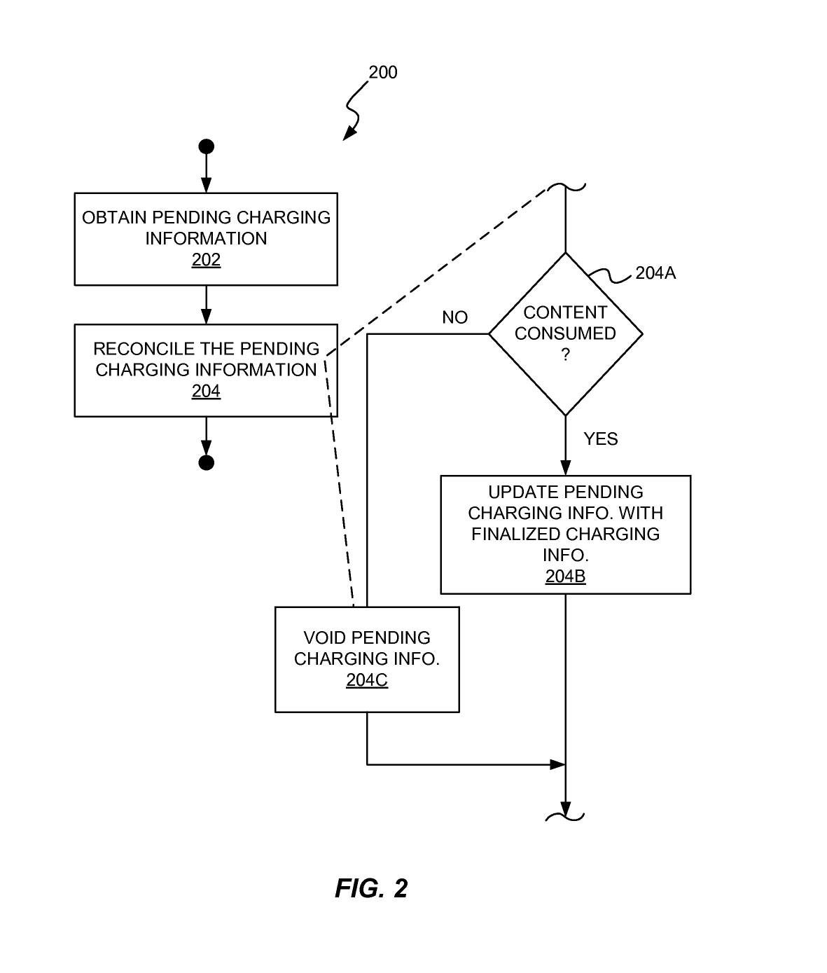

With the above processing variations in mind, FIG. 2 illustrates one embodiment of a method 200 of charging for content that is pre-fetched to a user device 12 via a communication network 10. The method 200 is implemented at a network node 28 associated with the communication network 10 and includes obtaining (Block 202) pending charging information responsive to the content being pre-fetched to the user device 12, where the content is referred to as pre-fetched content. While the pending charging information may be obtained based on receiving it from another node in the network 10, in one or more embodiments the contemplated network node 28 generates the pending charging information responsive to receiving explicit or implicit signaling that certain content has been pre-fetched to a given user device 12. In an advantageous embodiment contemplated herein, the signaling comprises control-plane signaling flowing within the network 10.

The method 200 further includes reconciling (Block 204) the pending charging information based on determining whether the pre-fetched content is subsequently consumed at the user device 12. Reconciliation as contemplated in the method 200 includes updating (Block 204B) the pending charging information with finalized charging information responsive to determining (YES from Block 204A) that the pre-fetched content is subsequently at least partly consumed at the user device 12, voiding (Block 204C) the pending charging information responsive to determining (NO from Block 204A) that the pre-fetched content is not subsequently consumed at the user device 12. Block 204A can therefore be understood as a decision block that is executed based on received control-plane signaling or other determination by the network node 28, and used to determine whether or to what extent the pre-fetched content in question has been at least partly consumed at the user device 12 in question.

As one example of an “other” determination, the pre-fetched content may have an expiration date or may otherwise be tied to a certain time window during which it must be consumed. Thus, the evaluation processing represented by the decision block 204A may be based on, or at least include, determining whether given pre-fetched content has expired before any corresponding indication of content consumption has been received.

With reference again to FIG. 1, a given user device 12 complements the above network-side processing based on including a communication interface 14 that is configured to receive content from a communication network 10 that is pre-fetched to the user device 12, and further based on including a processing circuit 16 operatively associated with the communication interface 14.

The processing circuit 16 is configured to store one or more items of pre-fetched content at the user device 12 for subsequent consumption, generate consumption information responsive to subsequent consumption of the pre-fetched content at the user device 12, and send control-plane signaling to the network node 28 in the communication network 10. The control-plane signaling indicates the consumption information and it may be sent directly to the network node 28, or may be sent indirectly to the network node 28.

Those of ordinary skill in the art will recognize that the processing circuit 16 may not be monolithic and instead may comprise more than one microprocessor, DSP, FPGA, ASIC, or other digital processing circuit. For example, the processing circuit 16 may include a trusted-computing-platform processor or other secure processing circuit that is adapted for handling the pre-fetching, storage and playback of pre-fetched content, particularly in the case where the pre-fetched content is protected by Digital Rights Management, DRM, or other security controls.

However, these lower-level details are not germane to understanding the relevant device-side teachings of interest in this disclosure, and it is enough for the ordinarily-skilled person to appreciate that the user device 12 includes a processing circuit 16 which is configured to support the pre-fetching of content from the network 10, and store pre-fetched content in a memory 18 for subsequent consumption at the user device 12.

In the illustration, the processing circuit 16 implements a pre-fetching entity, PE 20, that is configured to communicate via control-plane signaling with the network node 28 and/or other nodes in the network 10 that provide content pre-fetching services. Signaling in this regard includes signaling needed to set up or otherwise coordinate pre-fetched content downloading to the user device 12 and the subsequent return of corresponding consumption-information signaling from the user device 12.

The pre-fetching entity 20 and the processing circuit 16 at large shall be understood as being specially adapted to carry out the device-side processing contemplated herein, regardless of whether they are implemented using fixed circuitry or programmed circuitry, or some combination of both. For example, the processing circuit 16 may be configured to provide the pre-fetching functionality contemplated herein, based on its execution of program instructions comprising a computer program stored in the memory 18 or in another computer-readable medium accessible to the processing circuit 16.

In some embodiments, the processing circuit 16 is configured to track the amount of the pre-fetched content that is actually consumed at the user device 12 and indicate the consumed amount in the consumption information returned from the user device 12 to the network 10. In the same or other embodiments, the processing circuit 16 is configured to logically quantize the pre-fetched content into content chunks and to track the amount of the pre-fetched content that is actually consumed based on tracking content consumption on content-chunk basis. The chunk-based content consumption information is included in the consumption information returned to the network 10 in such embodiments.

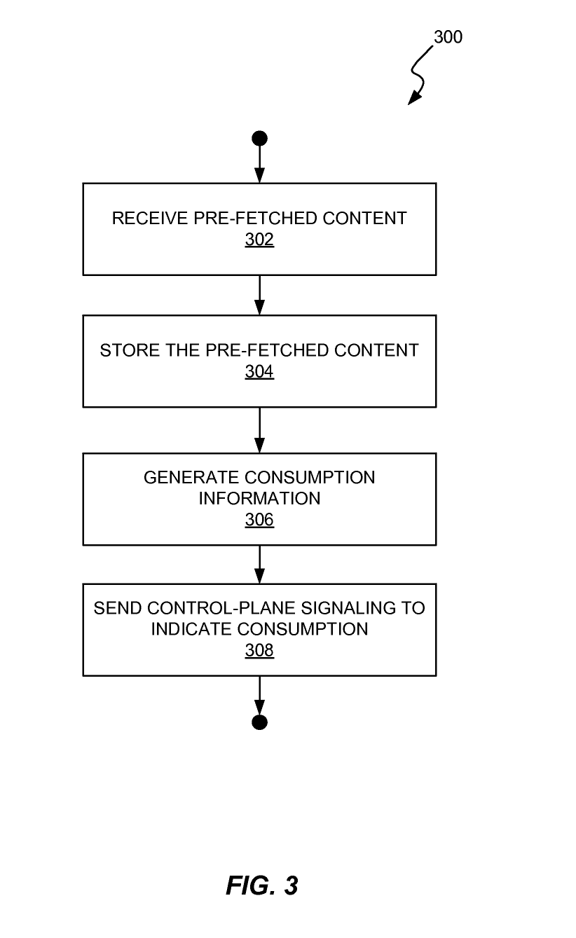

FIG. 3 illustrates an example embodiment of a method 300 of processing at a user device 12, which is in keeping with the above-described device-side functionality. Such processing is performed by the pre-fetching entity 20 or by equivalent processing circuitry in the user device 12, and it includes receiving (Block 302) content from the network 10 that is pre-fetched to the user device 12, and storing (Block 304) the pre-fetched content at the user device 12 for subsequent consumption. The method 300 further includes generating (Block 306) consumption information responsive to subsequent consumption of the pre-fetched content at the user device 12, and sending (Block 308) control-plane signaling to the network 10 indicating the consumption information.

As noted, the consumption information may be sent directly to the network node 28, or sent indirectly to the network node 28. In a particular example, the consumption information comprises control-plane signaling that is sent to the network node 28 directly, with the user device 12 and the network node 28 acting as protocol endpoints for that signaling. In other embodiments, the user device 12 sends control-plane signaling to another node in the network 10, which then forwards it to the network node 28, either directly or by repackaging the information according to the protocols associated with the communication interface 30 of the network node 28.

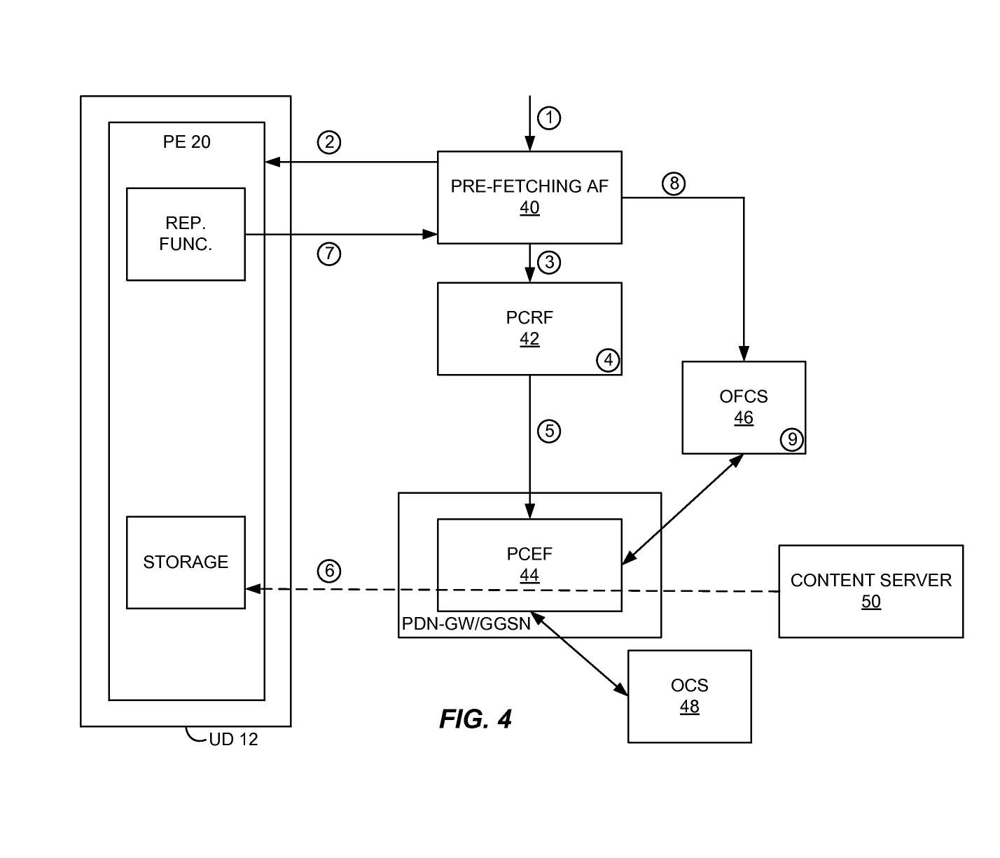

The particulars of the communication interface 30 depend on the location of the network node 28 within the network 10 and on the overall role played by the network node 28 within the network 10. Consider FIG. 4, for example, which illustrates a number of nodes or entities related to the charging functionality contemplated herein for pre-fetched content. The user device 12, abbreviated here as “UD 12,” is shown in a functional depiction of the pre-fetching entity, PE 20, which includes a reporting function—“REP. FUNC.” in the diagram—and storage for holding pre-fetched content.

One further sees a pre-fetching application function or AF 40, a Policy and Charging Rules Function, PCRF 42, a Policy Charging and Enforcement Function, PCEF 44, an Offline Charging System, OFCS 46, an Online Charging System, OCS 48, and a content server 50. The PCEF 44 may be implemented in a Packet Data Network, PDN, Gateway, GW, or in a Gateway GPRS Serving Node, GGSN, and the content server 50 may comprise a network node, such as a caching server within the network 10, or it may be external, such as the CP 34 shown in FIG. 1.

The network node 28 may be implemented in or co-located with the AF 40, the PCEF 44, and/or the OFCS 46. Notably, the network node 28 may be wholly contained within any one of these nodes, or may be implemented in a distributed fashion across two or more of them. For example, in some embodiments, the network node 28 comprises the PCEF 44, which is to say that the processing functionality described herein for the network node 28 is implemented via the processing circuitry and configuration of the PCEF 44, which will be understood to a computing node equipped with appropriate communication and/or signaling interfaces, e.g., for communication with the PCRF, the OFCS 46 and the OCS 48.

In such embodiments, the processing circuit 32 is implemented as part of the processing circuitry of the PCEF 44 and is configured to obtain the pending charging information by generating a pending charging event or by receiving such information from the AF 40 or elsewhere within the network 10, to update the pending charging information by generating a finalized charging event, and to send the finalized charging event to the OFCS 46, for generation of a corresponding Charging Data Record, CDR. In contrast to a conventional PCEF, then, the PCEF 44 recognizes charging events which are associated with the delivery of pre-fetched content and it intelligently treats those charging events as pending or unresolved until it is determined whether and/or how much of the pre-fetched content was actually consumed at the user device 12 in question.

For example, the processing circuit 32 is configured to generate the pending charging event responsive to receiving control-plane signaling indicating the pre-fetching of the pre-fetched content to the user device 12, and to generate the finalized charging event responsive to receiving control-plane signaling indicating the consumption of the pre-fetched content at the user device 12 and/or in response to determining expiry of the pre-fetched content. At least some such signaling may originate from or flow through the AF 40 and/or PCRF 42.

In another embodiment, the network node 28 comprises the OFCS 48—i.e., the network node 28 is implemented as part of the OFCS 46. Here, the processing circuit 32 is configured to obtain the pending charging information by generating a pending Charging Data Record, CDR, and to update the pending CDR by generating a finalized CDR. For example, the processing circuit 32 is configured to generate a pending CDR responsive to receiving a pending charging event from the PCEF 44 indicating that certain pre-fetched content has been pre-fetched to the user device 12, and to update the pending CDR with the finalized CDR responsive to receiving control-plane signaling indicating the consumption of the pre-fetched content at the user device 12.

In another embodiment, the network node 28 comprises the AF 40. Here, the processing circuit 32 is configured, for example, to update the pending charging information with finalized charging information based on generating a finalized charging event at the AF 40, or is configured to send signaling to PCEF 44, or to the OFCS 46, for generating the finalized charging event or charging data record. More broadly, the AF 40 in an example embodiment is configured to obtain pending charging information and either send that pending charging information to the PCEF 44 and/or the OFCS 46 for reconciliation, or to hold that pending charging information for performing reconciliation at the AF 40, such that the AF 40 holds pending charging information and sends only reconciled, finalized charging information downstream to the PCEF 44 and/or the OFCS 46.

The operator of the network 10 may have various motivations or there may be other factors favoring implementation of the network node 28 in any one of the nodes mentioned above. For example, if the network node 28 is implemented entirely within the PCEF 44, then the pre-fetching charging processing contemplated herein may be transparent to the OFCS 46, meaning that no modification of the OFCS 46 is needed as compared to current-day functionality. In this regard, the PCEF 44 may maintain internal “pending” charging event information and send only finalized charging event information to the OFCS 46, which means that the OFCS 46 need not worry about receiving or tracking pending charging information associated with pre-fetched content.

Of course, the PCEF 44 may be simplified by offloading some of the intelligence of the network node 28 to the OFCS 46. For example, the PCEF 44 can be configured to generate charging events for content pre-fetching, and need do no more than mark those events as “pending” or the like, and can let the OFCS 46 perform ultimate reconciliation of these pending records based on receiving subsequent indications as to whether or to what extent the pre-fetched content was actually consumed at the involved user device(s) 12. In such embodiments, the OFCS 46 may hold the pending charging events and defer CDR generation until it determines that the pre-fetched content was at least partly consumed, or it may generate pending CDRs corresponding to pending charging events, and then finalize or void the pending CDRs until it determines whether or to what extent the pre-fetched content was consumed.

Locating the intelligence of the network node 28 even further upstream, e.g., at the AF 40 can allow the PCEF 44 and/or of the OFCS 46 to remain conventional. For example, the AF 40 can buffer or otherwise withhold the signaling that would otherwise be used to generate charging events, until the AF 40 determines whether and/or how much of given pre-fetched content was actually consumed at a given user device 12. The AF 40 in this sense would act as a gatekeeper and not allow charging information to flow into the PCRF 42, PCEF 44, and/or OFCS 46 until it reconciles the pending charging information against corresponding consumption information reported from or for the involved user device 12.

With the above in mind, FIG. 4 can be understood according to the following example flow, which is non-limiting with respect to the teachings herein: at Step 1, the AF 40 receives a request to pre-fetch certain content for a certain user device 12, or for a group of user devices 12; at Step 2, the AF 40 send signaling to the PEs 20 at the involved user device(s) 12, to initiate pre-fetching of the certain content; at Step 3, pre-fetching session information, including the Internet Protocol, IP, tuple, is provided to the PCRF 42, which at Step 4 may enforce a policy decision that the pre-fetching should be handled as a pending charging event; at Step 5, the PCRF 42 sends charging pending information to the PCEF 44; at Step 6, the involved content is pre-fetched to the PE 20 of the user device(s) 12; at Step 7, the PCEF 44 generates pending charging events as the corresponding pending charging information and sends that information to the OFCS 46; subsequently at Step 8, the OFCS 46 receives ACK/NACK signaling from the AF 40, which indicates consumed or not-consumed status for the pre-fetched content with respect to the involved user device(s) 12; and in response at Step 9, the OFCS 46 performs pending CDR reconciliation—i.e., it generates finalized CDRs for consumed pre-fetched content and voids pending CDRs for pre-fetched content that was not (timely) consumed at the user device(s) 12.

However implemented, the network node 28 is configured to determine that the pre-fetched content was not subsequently consumed at the user device 12, e.g., based on receiving control-plane signaling indicating that the pre-fetched content was not subsequently consumed at the user device 12. Additionally, or alternatively, the network node 28 is configured to determine that given pre-fetched content was not subsequently consumed at the user device 12, based on detecting lapse of an expiration date associated with the pre-fetched content in the absence of receiving any indication of consumption of the pre-fetched content at the user device 12.

Of course, it is contemplated herein to provide pre-fetched content charging functionality with respect to various levels of “richness” associated with the consumption information reported by a user device 12, for given pre-fetched content stored at the user device 12. In this sense, the user device 12 will be understood as supporting the pre-fetching of content into its local storage, for subsequent consumption. In some embodiments, the user device 12 may be configured to compile reports indicating what pre-fetched content has been consumed and/or what pre-fetched content has not been consumed, and to send such reports to the network 10. In turn, the network node 28 may keep obtain pending charging information for all content that has been pre-fetched to a given user device 12, e.g., by tracking such pre-fetching or otherwise receiving signaling indicating what has been pre-fetched to given user devices 12.

Such operations enable more flexible policy charging rules that may take into account not only information about content being pre-fetched, but also which of this content is being consumed at user devices 12 and under which conditions the content is pre-fetched and/or consumed, e.g. which RAT, time of the day, high mobility, areas without coverage, etc.

The network 10 can push such content based on its own analytics, where the users or subscribers associated with the devices to which the content is being pre-fetched should not be charged for the pre-fetched content unless it is actually consumed in whole or in part. In other instances, the user of a user device 12, or applications running on the user device 12, initiate pre-fetching. While the premiums or other charging considerations associated with user-initiated pre-fetching may be different, the underlying use of pending and finalized charging information as taught herein still holds.

Further, it is also contemplated herein that content providers may have business agreements with the operator of the network 10. For example, while a user may not be charged for pre-fetched content unless or until he or she actually consumes that pre-fetched content via the involved user device 12, it may be that content providers pay fees to the network operator to have their content pre-fetched to user devices 12. Of course, such pre-fetching may be done at times advantageous to the network operator, such as at times of otherwise low utilization of the network 10, so that the content providers can be offered a discount as compared to what it would cost to stream or otherwise transmit the same content to users on-demand, which may coincide with peak usage times.

In any case, the consumption information as generated by or for a user device 12 may include an identifier of the content, e.g., a ID number or other unique content identifier, an indication as to whether or how much of the identified content was consumed, the time at which the content was consumed and/or the time at which the content was deleted from the pre-fetched content storage of the user device 12, the RAT and/or RAN involved in pre-fetching the content, the location of the user device 12 at the time of pre-fetching and/or at the time of consumption, the mobility pattern or history associated with the user device 12, the size of the pre-fetched content, a type or category of the pre-fetched content, an identifier of the content provider and/or an identifier of the network cache from which the content was pre-fetched, and the reason the content was pre-fetched, e.g., device-initiated, network-initiated, etc.

The user device 12 in some embodiments is configured to send consumption reports to the AF 40, which detail the pre-fetched content that has been actually consumed at the user device 12 and/or identify all content which has been pre-fetched to the user device 12 and indications as to whether that content has or has not been consumed, whether the content is still stored in the user device 12, etc. Such reporting may use over-the-top signaling messages and the reports may be scheduled for times when the network load is low, or otherwise when the transmission costs are lowest.

Of course, the AF 40 need not be involved. For example, the consumption information may be sent from a given user device 12 to a PCEF 44, e.g., via forwarding from a PDN-GW/GGSN. These messages can be delivered, for example, using Radio Resource Control, RRC, or Non-Access Stratum, NAS, signaling. In the case of RRC messaging, a user device 12 containing consumption information could report that information upon RRC establishment, for example. Upon the reception, the serving base station in the network 10 would transfer the information to the network node 28, for use in obtaining and/or reconciling pending charging information. Such information also may be actively requested from the user device 12.

In the case of NAS messages, consumption information could be reported when sending Tracking Area Updates, in conjunction with ATTACH messages, or upon request. For example, the PDN-GW may request that a given user device 12 send consumption information. Minimization of Drive Test, MDT, configuration and reporting procedures also can be used for consumption information report.

It is also contemplated herein that a user device 12 could send “ACKS” for consumed pre-fetched content and/or send “NACKS” for pre-fetched content that is not consumed. A NACK may be sent, for example, when pre-fetched content stored at the user device 12 expires or otherwise becomes outdated, or is deleted from the user device 12, e.g., as part of first-in-first-out storage management process. Explicit NACKs can be beneficial from a network point of view, because it allows more timely removal of pending charging information as compared to simply waiting for content consumption periods to expire. Such NACKs also may be generated within the network 10, e.g., based on the network node 28 determining that pre-fetched content stored at a given user device 12 has become outdated, etc.

The consumption information may also comprise or be derived implicitly. For example, the network node 28 or another node in the network 10 can obtain consumption information for pre-fetched content based on looking for “GETs” in HTTP headers, or other signaling that is characteristic of content consumption at the user device 12. In one approach, the network 10 intercepts HTTP messages with conditional GETs associated with pre-fetched content and analyze the responses from the involved application or content server. Such HTTP responses may contain a new version of the content which should be considered for charging, e.g., the user should not be charged for pre-fetched content in instances where updated or newer content will be consumed instead of the corresponding pre-fetched content already stored at the user device 12. On the other hand, if a user device 12 issues a conditional GET for content that is already pre-fetched to user device 12 and the HTTP response from the associated application or cache/content server indicates that the pre-fetched content is still current, the network 10 knows that consumption will be from the storage of the user device 12 and the pending/reconciliation taught herein for pre-fetched content applies.

The network node 28 or another node in the network 10 also may use other techniques to implicitly determine that pre-fetched content has been at least partly consumed at a given user device 12. For example, for DRM-protected or other secure pre-fetched content, the user device 12 may need to obtain a license, a token, a decryption key, or the like in order to playback or otherwise consume the content. The network 10 may therefore monitor, track, or otherwise discover that a given user device has requested such information and interpret that request as an implicit indication that the user of the user device 12 has or intends to at least partly consume the corresponding pre-fetched content. Such approaches may or may not allow much or any gradation in determining how much of the pre-fetched content is actually consumed, but at least the network node 28 can accurately conclude that at least some consumption has occurred and it may be that partial charging is not permitted in any case—i.e., any consumption results in a full assessment of charges against the account of the user associated with the user device 12.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1. A method of charging for content that is pre-fetched to a user device via a communication network, said method implemented at a network node associated with the communication network and comprising:
obtaining pending charging information for the content pre-fetched to the user device, said content referred to as pre-fetched content;
reconciling the pending charging information based on determining whether the pre-fetched content is subsequently consumed at the user device, including:
updating the pending charging information with finalized charging information responsive to determining that the pre-fetched content is subsequently at least partly consumed at the user device; and
voiding the pending charging information responsive to determining that the pre-fetched content is not subsequently consumed at the user device.

2. The method of claim 1, wherein updating the pending charging information with the finalized charging information includes indicating whether the pre-fetched content was fully or partly consumed at the user device.

3. The method of claim 1, wherein updating the pending charging information with the finalized charging information includes generating the finalized charging information to account for the amount of the pre-fetched content that was actually consumed at the user device.

4. The method of claim 3, wherein the pre-fetched content is logically quantized into content chunks and wherein generating the finalized charging information to account for the amount of pre-fetched content that was actually consumed at the user device comprises accounting on a content-chunk basis.

5. The method of claim 1, wherein the finalized charging information includes one or more metadata items for the pre-fetched content, including one or more of: a time at which the pre-fetched content was delivered to the user device; a location of the user device when the pre-fetched content was delivered to the user device; and a type or identity of the Radio Access Network, RAN, used to deliver the pre-fetched content to the user device.

6. The method of claim 1, wherein the network node comprises a Policy and Charging Enforcement Function, PCEF, wherein obtaining the pending charging information comprises generating a pending charging event responsive to the content being pre-fetched to the user device, wherein updating the pending charging information comprises generating a finalized charging event, and wherein the method further includes sending the finalized charging event to an Offline Charging System, OFCS, for use in generating a corresponding Charging Data Record, CDR.

7. The method of claim 6, wherein obtaining the pending charging event comprises generating the pending charging event responsive to receiving control-plane signaling indicating the pre-fetching of the pre-fetched content to the user device.

8. The method of claim 6, wherein generating the finalized charging event comprises generating the finalized charging event responsive to receiving control-plane signaling indicating the consumption of the pre-fetched content at the user device.

9. The method of claim 1, wherein the network node comprises an Offline Charging System, OFCS-, wherein obtaining the pending charging information comprises generating a pending Charging Data Record, CDR, responsive to the content being pre-fetched to the user device, and wherein updating the pending charging information comprises generating a finalized CDR.

10. The method of claim 9, wherein generating the pending CDR comprises generating the pending CDR responsive to receiving a pending charging event indicating that the pre-fetched content has been pre-fetched to the user device.

11. The method of claim 9, wherein updating the pending CDR with the finalized CDR comprises updating the pending CDR responsive to receiving control-plane signaling indicating the consumption of the pre-fetched content at the user device.

12. The method of claim 1, wherein determining that the pre-fetched content is not subsequently at least partly consumed at the user device comprises at least one of: receiving control-plane signaling indicating that the pre-fetched content was not subsequently consumed at the user device, and detecting lapse of an expiration date associated with the pre-fetched content in the absence of receiving any indication of consumption of the pre-fetched content at the user device.

13. The method of claim 1, wherein the network node comprises an Application Function, AF, and wherein updating the pending charging information with finalized charging information comprises generating a finalized charging event at the AF, or sending signaling to a Policy and Charging Enforcement Function, PCEF, or to a Offline Charging System, OFCS, for generating the finalized charging event or charging data record.

14. A network node configured for operation in a communication network that pre-fetches content to a user device, said network node comprising:
a communication interface configured to receive signaling indicating that the content has been pre-fetched to the user device; and
a processing circuit operatively associated with the communication interface and configured to obtain pending charging information responsive to the content being pre-fetched to the user device, said content referred to as pre-fetched content, and to reconcile the pending charging information based on determining whether the pre-fetched content is subsequently consumed at the user device, based on the processing circuit being configured to:
update the pending charging information with finalized charging information responsive to determining that the pre-fetched content is subsequently at least partly consumed at the user device; and
void the pending charging information responsive to determining that the pre-fetched content is not subsequently at least partly consumed at the user device.

15. The network node of claim 14, wherein the processing circuit is configured to update the pending charging information with finalized charging information that indicates whether the pre-fetched content was fully or partly consumed at the user device.

16. The network node of claim 14, wherein the processing circuit is configured to update the pending charging information with finalized charging information based on generating the finalized charging information to account for the amount of the pre-fetched content that was actually consumed at the user device.

17. The network node of claim 16, wherein the pre-fetched content is logically quantized into content chunks and wherein the processing circuit is configured to generate the finalized charging information to account for the amount of pre-fetched content that was actually consumed at the user device on a content-chunk basis.

18. The network node of claim 14, wherein the finalized charging information includes one or more metadata items for the pre-fetched content including one or more of: a time at which the pre-fetched content was delivered to the user device; a location of the user device when the pre-fetched content was delivered to the user device; and a type or identity of the Radio Access Network, RAN, used to deliver the pre-fetched content to the user device.

19. The network node of claim 14, wherein the network node comprises a Policy and Charging Enforcement Function, PCEF, wherein the processing circuit is configured to obtain the pending charging information by generating a pending charging event, to update the pending charging information by generating a finalized charging event, and to send the finalized charging event to an Offline Charging System, OFCS, for generation of a corresponding Charging Data Record, CDR.

20. The network node of claim 19, wherein the processing circuit is configured to generate the pending charging event responsive to receiving control-plane signaling indicating the pre-fetching of the pre-fetched content to the user device.

21. The network node of claim 19, wherein the processing circuit is configured to generate the finalized charging event responsive to receiving control-plane signaling indicating the consumption of the pre-fetched content at the user device.

22. The network node of claim 14, wherein the network node comprises an Offline Charging System, OFCS, wherein the processing circuit is configured to obtain the pending charging information by generating a pending Charging Data Record, CDR, and to update the pending CDR by generating a finalized CDR.

23. The network node of claim 22, wherein the processing circuit is configured to generate the pending CDR responsive to receiving a pending charging event indicating that the pre-fetched content has been pre-fetched to the user device.

24. The network node of claim 22, wherein the processing circuit is configured to update the pending CDR with the finalized CDR responsive to receiving control-plane signaling indicating the consumption of the pre-fetched content at the user device.

25. The network node of claim 14, wherein the processing circuit is configured to determine that the pre-fetched content was not subsequently consumed at the user device based on at least one of: receiving control-plane signaling indicating that the pre-fetched content was not subsequently consumed at the user device and detecting lapse of an expiration date associated with the pre-fetched content in the absence of receiving any indication of consumption of the pre-fetched content at the user device.

26. The network node of claim 14, wherein the network node comprises an Application Function, AF, and wherein the processing circuit is configured to update the pending charging information with finalized charging information based on generating a finalized charging event at the AF, or based on sending signaling to a Policy and Charging Enforcement Function, PCEF, or to a Offline Charging System, OFCS, for generating the finalized charging event or charging data record.

27. A method in a user device comprising:
receiving content from a communication network that is pre-fetched to the user device, said content being referred to as pre-fetched content;
storing the pre-fetched content at the user device for subsequent consumption;
generating consumption information responsive to subsequent consumption of the pre-fetched content at the user device; and
sending control-plane signaling to a network node in the communication network indicating the consumption information.

28. The method of claim 27, wherein generating the consumption information comprises tracking the amount of the pre-fetched content that is actually consumed at the user device and indicating the consumed amount in the consumption information.

29. The method of claim 28, wherein the pre-fetched content is logically quantized into content chunks and wherein tracking the amount of the pre-fetched content that is actually consumed comprises tracking content consumption on content-chunk basis.

30. A user device comprising:
a communication interface configured to receive content from a communication network that is pre-fetched to the user device, said content being referred to as pre-fetched content;
a processing circuit operatively associated with the communication interface and configured to:
store the pre-fetched content at the user device for subsequent consumption;
generate consumption information responsive to subsequent consumption of the pre-fetched content at the user device; and
send control-plane signaling to a network node in the communication network indicating the consumption information.

31. The user device of claim 30, wherein the processing circuit is configured to track the amount of the pre-fetched content that is actually consumed at the user device and indicate the consumed amount in the consumption information.

32. The user device of claim 31, wherein the processing circuit is configured to logically quantize the pre-fetched content into content chunks and to track the amount of the pre-fetched content that is actually consumed based on tracking content consumption on content-chunk basis.
